(19) United States
(12) Patent Application Publication
(10) Pub. No.: US 2024/0344947 A1
(43) Pub. Date: Oct. 17, 2024

(54) Tubing Weld Test Assembly

(71) Applicant: Terumo BCT, Inc., Lakewood, CO (US)

(72) Inventors: Bijesh THODUVAYIL, Thiruvananthapuram (IN); Bravish BABU M, Thiruvananthapuram (IN); Monsi KURIAN, Kottayam (IN)

(21) Appl. No.: 18/616,421

(22) Filed: Mar. 26, 2024

Related U.S. Application Data
(60) Provisional application No. 63/458,678, filed on Apr. 12, 2023.

(51) Int. Cl. G01N 3/08; G01N 3/04

(52) U.S. Cl. CPC G01N 3/08; G01N 3/04; G01N 2203/0016; G01N 2203/0041; G01N 2203/0274; G01N 2203/0296

(57) ABSTRACT

An assembly for testing a quality of a weld joining a first section of tubing to a second section of the tubing includes a track, a first tubing engagement structure coupled to the track and translatable along the track, a second tubing engagement structure connected to the track, an actuator, and a load cell. The actuator is operable to translate the first tubing engagement structure along the track in a first direction toward the second tubing engagement structure and in a second direction away from the second tubing engagement structure. The load cell is operable to measure at least one of a compression load and a tensile load applied to the tubing by the first and second tubing engagement structures.

### CROSS-REFERENCE TO RELATED APPLICATIONS

This application claims the benefit of U.S. Provisional Application No. 63/458,678 filed Apr. 12, 2023. The entire disclosure of the above application is incorporated herein by reference.

### FIELD

The present disclosure relates to tubing weld test assemblies.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Ends of separate pieces of sterile tubing are welded together for various reasons, particularly within the blood and cell technological fields. It is desirable to know the pull-strength and burst strength of tubing, particularly if there is a weld in the tubing, to ensure that the tubing can withstand the compressive and tensile loads that it is likely to be subjected to in the field. It may be possible to obtain the pull-strength and burst strength of tubing by testing the tubing using an ultimate testing machine (UTM). However, UTMs are costly, large, and heavy, and are not transportable in the field.

### SUMMARY

The present disclosure describes an assembly for testing a quality of a weld joining a first section of tubing to a second section of the tubing. In one example, the assembly includes a track, a first tubing engagement structure coupled to the track and translatable along the track, a second tubing engagement structure connected to the track, an actuator, and a load cell. The actuator is operable to translate the first tubing engagement structure along the track in a first direction toward the second tubing engagement structure and in a second direction away from the second tubing engagement structure. The load cell is operable to measure at least one of a compression load and a tensile load applied to the tubing by the first and second tubing engagement structures.

In one aspect, the actuator is manually operated.

In one aspect, the assembly further includes a first end cap connected to a first end of the track and a second end cap connected to a second end of the track. The actuator includes a threaded rod and a control knob. The threaded rod extends through the first end cap, engages internal threads in the first tubing engagement structure, and extends into the second end cap. The control knob is connected to the threaded rod and is rotatable by hand to translate the first tubing engagement structure along the track.

In one aspect, the first tubing engagement structure includes a carriage coupled to the track, a first jaw support connected to the carriage, and a first set of jaws mounted to the first jaw support and adjustable to clamp and release the first section of the tubing, and the second tubing engagement structure includes a second jaw support connected to the second end cap and a second set of jaws mounted to the second jaw support and adjustable to clamp and release the second section of the tubing.

In one aspect, the load cell connects the first jaw support to the carriage.

In one aspect, the load cell is operable to measure a peak value of the tensile load applied to the tubing as the first tubing engagement structure is translated away from the second tubing engagement structure.

In one aspect, the first tubing engagement structure includes a first threaded shaft and a first handle fixed to the first threaded shaft, the first threaded shaft extending into the first jaw support in a third direction and engaging one jaw of the first set of jaws, and the second tubing engagement structure includes a second threaded shaft and a second handle fixed to the second threaded shaft, the second threaded shaft extending into the second jaw support in a fourth direction and engaging one jaw of the first set of jaws. The first handle is rotatable to adjust a distance between the first set of jaws, and the second handle is rotatable to adjust a distance between the second set of jaws.

In one aspect, the first tubing engagement structure includes a first compression insert configured to be attached to the first jaw support and to provide a flat surface for pressing against a first side of the tubing at the weld, and the second tubing engagement structure includes a second compression insert configured to be attached to the second jaw support and to provide a flat surface for pressing against a second side of the tubing at the weld.

In one aspect, the load cell is operable to measure a peak value of the compression load applied to the tubing as the first tubing engagement structure is translated toward the second tubing engagement structure.

In one aspect, the first and second compression inserts are configured to fit over the first and second sets of jaws, respectively.

In one aspect, the first and second jaw supports and the first and second sets of jaws are made of metal, and the first and second compression inserts are made of plastic.

In one aspect, the track extends through the first tubing engagement structure and into the second tubing engagement structure.

In one aspect, the assembly further includes an electronic display configured to display the at least one of the compression load and the tensile load measured by the load cell.

In another example, the assembly includes a first tubing engagement structure configured to engage at least one of the first section of the tubing and a first side of the tubing at the weld, a second tubing engagement structure configured to engage at least one of the second section of the tubing and a second side of the tubing at the weld, an actuator that is manually operable to adjust a distance between the first and second tubing engagement structures, and a load cell operable to measure at least one of a compression load and a tensile load applied to the tubing by the first and second tubing engagement structures.

In one aspect, the assembly further includes a track, the first tubing engagement structure is coupled to the track, the second tubing engagement structure is fixed relative to the track, and the actuator is operable to translate the first tubing engagement structure along the track.

In one aspect, the assembly further includes a first end cap connected to a first end of the track, and a second end cap connected to a second end of the track, the actuator including a threaded rod and a control knob, the threaded rod extending through the first end cap, engaging internal threads in the first tubing engagement structure, and extending into the second end cap. The control knob is connected to the threaded rod and is rotatable by hand to translate the first tubing engagement structure along the track.

In yet another example, the assembly includes a first tubing engagement structure including a first jaw support and a first set of jaws mounted to the first jaw support and adjustable to clamp and release the first section of the tubing, a second tubing engagement structure including a second jaw support and a second set of jaws mounted to the second jaw support and adjustable to clamp and release the second section of the tubing, an actuator operable to move the first tubing engagement structure in a first direction toward the second tubing engagement structure and in a second direction away from the second tubing engagement structure, and a load cell operable to measure at least one of a compression load and a tensile load applied to the tubing by the first and second tubing engagement structures.

In one aspect, the assembly further includes a track, the first tubing engagement structure includes a carriage coupled to the track and supporting the first jaw support, the second tubing engagement structure is fixed relative to the track, and the actuator is operable to translate the first tubing engagement structure along the track.

In one aspect, the first tubing engagement structure includes a first threaded shaft and a first handle fixed to the first threaded shaft, the first threaded shaft extending into the first jaw support in a third direction perpendicular to the first and second directions, and the second tubing engagement structure includes a second threaded shaft and a second handle fixed to the second threaded shaft, the second threaded shaft extending into the second jaw support in a fourth direction opposite of the third direction. The first handle is rotatable to adjust a distance between the first set of jaws, and the second handle is rotatable to adjust a distance between the second set of jaws.

In one aspect, the first tubing engagement structure includes a first compression insert configured to be attached to the first jaw support and to provide a flat surface for pressing against a first side of the tubing at the weld, and the second tubing engagement structure includes a second compression insert configured to be attached to the second jaw support and to provide a flat surface for pressing against a second side of the tubing at the weld.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1 and 2 are perspective views of a tubing weld test assembly according to the principles of the present disclosure, with compression inserts exploded from the remainder of the assembly to illustrate jaws otherwise covered by the inserts;

FIG. 3 is another perspective view of the tubing weld test assembly of FIGS. 1 and 2 with the compression inserts omitted;

FIG. 4 is a top view of the tubing weld test assembly of FIGS. 1 and 2 with the jaws shown in their open positions;

FIG. 5 is a top view of the tubing weld test assembly of FIGS. 1 and 2 with the jaws shown in their closed positions;

FIG. 6 is a top view of the tubing weld test assembly of FIGS. 1 and 2 with one tubing engagement structure moved away from another tubing engagement structure to break a weld between sections of tubing;

FIG. 7 is a perspective view of the tubing weld test assembly of FIGS. 1 and 2 with the compression inserts installed;

FIG. 8 is a top view of the tubing weld test assembly of FIGS. 1 and 2 with the compression inserts installed and a welded piece of tubing disposed therebetween;

FIG. 9 is a top view of the tubing weld test assembly of FIGS. 1 and 2 with one of the tubing engagement structures moved closer to the other tubing engagement structure to burst a weld between sections of the tubing;

FIG. 10 is a side view of the tubing weld test assembly of FIGS. 1 and 2 without the compression inserts; and

FIGS. 11 through 13 are section views of the tubing weld test assembly of FIGS. 1 and 2 taken along lines 11-11 through 13-13, respectively, shown in FIG. 10.

In the drawings, reference numbers may be reused to identify similar and/or identical elements.

### DETAILED DESCRIPTION

A tubing weld test assembly according to the present disclosure is a hand-operated device that allows an operator to measure the pull-strength of tubing and the burst strength of tubing. In addition, the tubing weld test assembly is small and lightweight, and therefore is portable in the field (e.g., by hand). To evaluate the pull-strength of tubing, an operator inserts tubing into the tubing weld test assembly, clamps the tubing on opposite sides of a weld in the tubing using two sets of jaws, and rotates a control knob to move one set of jaws away from the other set of jaws. A load cell outputs the tensile load applied to the tubing as the one set of jaws is moved away from the other set of jaws, and an electronic display shows the peak value of the tensile load, which typically corresponds to a time just before the weld in the tubing breaks.

To evaluate the burst strength of tubing, an operator attaches a compression insert over each set of jaws for pressing against one longitudinal side of the tubing. The operator then inserts the tubing into the tubing weld test assembly and moves one of the compression inserts toward the other one of the compression inserts to compress the tubing between the compression inserts. The load cell outputs the compression load applied to the tubing as the one compression insert is moved toward the other compression insert, and the display shows the peak value of the compression load, which typically corresponds to a time just before the weld in the tubing bursts.

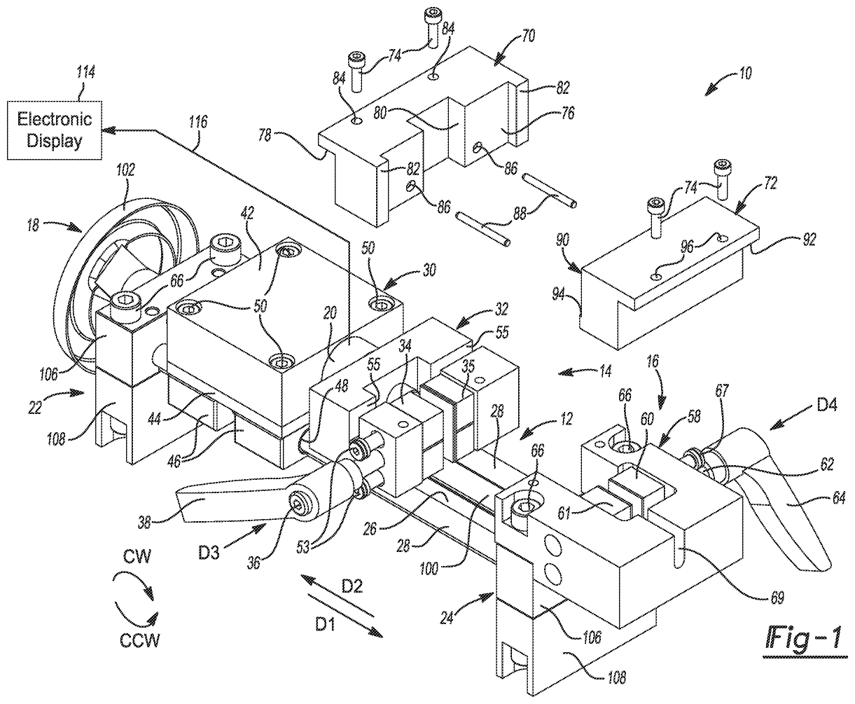

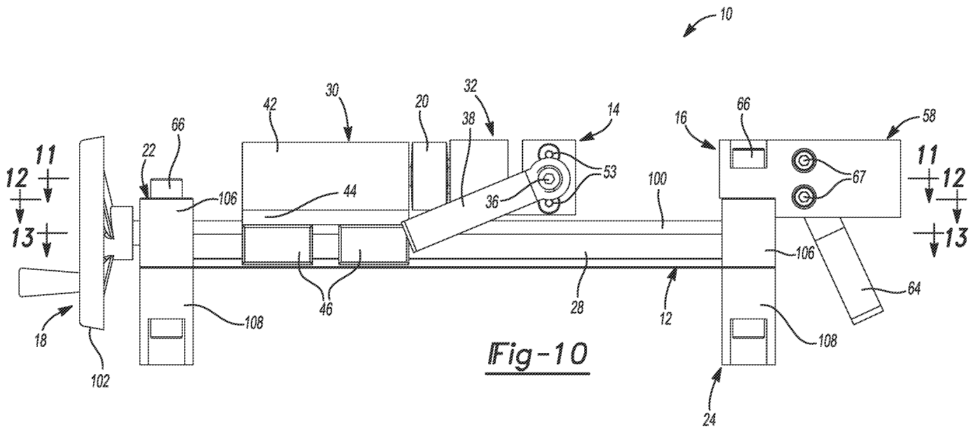

Referring now to FIGS. 1 through 3 and FIGS. 10 through 13, a tubing weld test assembly 10 includes a track 12, a first tubing engagement structure 14, a second tubing engagement structure 16, an actuator 18, a load cell 20, a first end cap 22, and a second end cap 24. The track 12 includes an elongated strip 26 having a rectangular cross section and a pair of cylindrical guide rails 28 extending along longitudinal edges thereof. The guide rails 28 are attached to and project from upper corners of the elongated strip 26. The track 12 may be made of a metal such as aluminum.

The first tubing engagement structure 14 is coupled to the track 12. In addition, the first tubing engagement structure 14 is translatable along the track 12 in a first direction D1 toward the second tubing engagement structure 16 and in a second direction D2 away from the second tubing engagement structure 16. The track 12 extends through the first tubing engagement structure 14 and into the second tubing engagement structure 16.

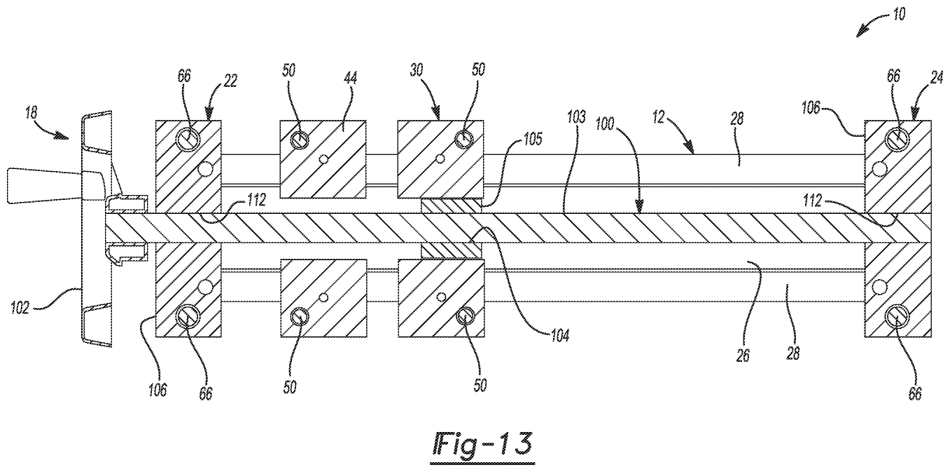

The first tubing engagement structure 14 includes a carriage 30, a first jaw support 32, a first set of jaws 34, 35, a first threaded shaft 36, and a first handle 38. In the example shown, the carriage 30 includes an upper block 42, a middle block 44, and four lower blocks 46, and the guide rails 28 of the track 12 extend through holes 48 in the lower blocks 46. The holes 48 in the lower blocks 46 are larger than the guide rails 28 of the track 12, yielding a clearance fit therebetween that allows the carriage 30 to slide along and relative to the track 12. The upper, middle, lower blocks 42, 44, and 46 may be attached to one another using fasteners 50. The track 12, including the strip 26 and the guide rails 28, the carriage 30, including the upper block 42, the middle block 44, and the lower blocks 46, a threaded rod 100, a nut 105 (FIG. 13) fixed inside the carriage 30 and receiving the threaded rod 100, and upper blocks 106 of the first and second end caps 22 and 24 may be part of a slide module, such as drylin® SLW-1040 linear module. The carriage 30 is fixed on the slide module using the fasteners 50.

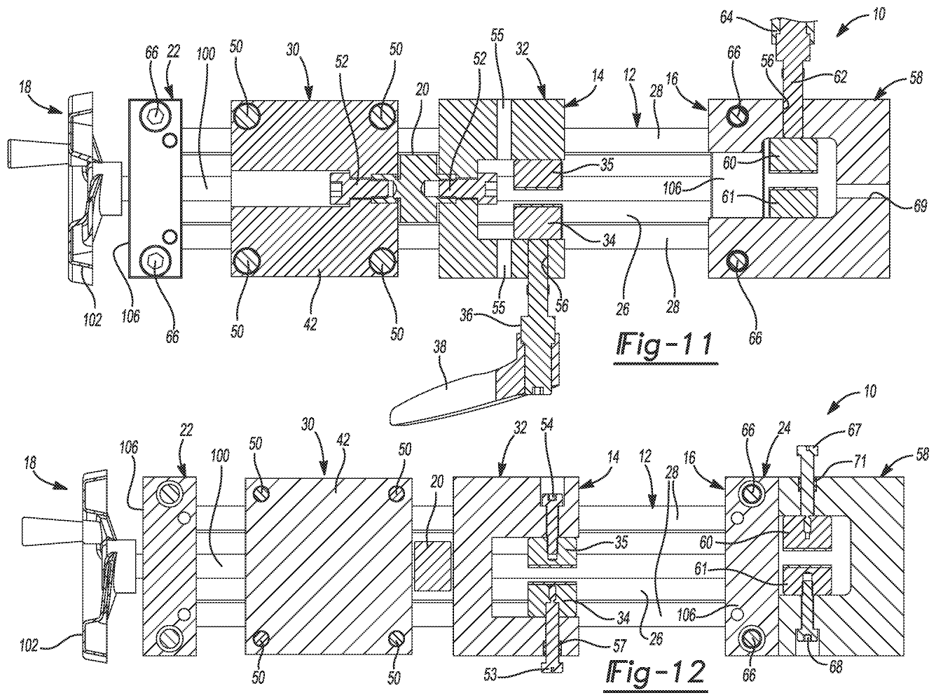

As best shown in FIG. 11, the first jaw support 32 is connected to the carriage 30 through the loads cell 20 and a pair of fasteners 52. As best shown in FIG. 12, the jaws 34, 35 are mounted to the first jaw support 32 using fasteners 53, 54, respectively, and at least one of the jaws 34, 35 is adjustable to clamp and release tubing. The fasteners 53 securing the jaw 34 are shoulder bolts that allow the jaw 34 to move. The fasteners 54 securing the jaw 35 are socket head cap screws that fix the jaw 35 in place. In the example shown, the jaw 34 is adjustable. In various implementations, both of the jaws 34, 35 may be adjustable in the same way that the jaw 34 is adjustable.

The jaw 34 is moveable toward and away from the jaw 35 to adjust the distance between the jaws 34, 35, and thereby clamp and release tubing. The heads of the fasteners 53 attaching the jaw 34 to the first jaw support 32 are not seated against the first jaw support 32 to allow the jaw 34 to move relative to the first jaw support 32. The first jaw support 32 has a pair of slots 55 for receiving tubing and temporarily holding the tubing in place as the jaw 34 is moved to clamp the tubing. In various implementations, tubing may be secured to the first and second tubing engagement structures 14 and 16 using mechanisms other than jaws, such as elastic bands or straps.

As best shown in FIGS. 1 and 11, the first threaded shaft 36 extends into the first jaw support 32 in a third direction D3, engages internal threads 56 in the first jaw support 32, and abuts the jaw 34. The third direction D3 is perpendicular to the first and second directions D1 and D2. The first handle 38 is fixed to the first threaded shaft 36 using, for example, a press fit. The first threaded shaft 36 and the first handle 38 may be part of a clamp lever.

The first handle 38 is rotatable in a clockwise direction CW to decrease the distance between the jaws 34, 35. The first handle 38 is rotatable in a counterclockwise direction CCW to allow the distance between the jaws 34, 35 to be increased. As best shown in FIG. 12, compression springs 57 are inserted into counterbores in the first jaw support 32 adjacent to the heads of the fasteners 53, and the springs 57 act on the underside surfaces of the heads to bias the jaw 34 away from the jaw 35. Alternatively, the distance between the jaws 34, 35 may be increased by moving the jaw 34 by hand.

The second tubing engagement structure 16 is fixed relative to the track 12. The second tubing engagement structure 16 includes a second jaw support 58, a second set of jaws 60, 61 mounted to the second jaw support 58, a second threaded shaft 62, and a second handle 64. The second jaw support 58 is connected to the second end cap 24 using fasteners 66. The track 12, including the strip 26 and the guide rails 28, and the upper block 42, the middle block 44, and the lower blocks 46 may be part of a slide module, as noted above, and the second end cap 24 may be fixed on the slide module. The first and second end caps 22 and 24, the carriage 30, the first and second jaw supports 32 and 58, and the first and second sets of jaws 34, 35 and 60, 61 may be made of one or more metals such as aluminum and/or stainless steel.

As best shown in FIG. 12, the jaws 60, 61 are mounted to the second jaw support 58 using fasteners 67, 68, respectively, and at least one of the jaws 60, 61 is adjustable to clamp and release tubing. The fasteners 67 securing the jaw 60 are shoulder bolts that allow the jaw 60 to move. The fasteners 67 securing the jaw 61 are socket head cap screws that fix the jaw 61 in place. In the example shown, the jaw 60 is adjustable. In various implementations, both of the jaws 60, 61 may be adjustable in the same way that the jaw 60 is adjustable.

The jaw 60 is moveable toward and away from the jaw 61 to adjust the distance between the jaws 60, 61, and thereby clamp and release tubing. The heads of the fasteners 67 attaching the jaw 60 to the second jaw support 58 are not seated against the second jaw support 58 to allow the jaw 60 to move relative to the second jaw support 58. The second jaw support 58 has a slot 69 for receiving tubing and temporarily holding the tubing in place as the jaw 60 is moved to clamp the tubing.

As best shown in FIGS. 1 and 11, the second threaded shaft 62 extends into the second jaw support 58 in a fourth direction D4, engages internal threads 56 in the first jaw support 32, and abuts the jaw 60. The fourth direction D4 is opposite of the third direction D3. The second handle 64 is fixed to the second threaded shaft 62 using, for example, a press fit. The second threaded shaft 62 and the second handle 64 may be part of a clamp lever.

The second handle 64 is rotatable in the clockwise direction CW to decrease the distance between the jaws 60, 61. The second handle 64 is rotatable in the counterclockwise direction CCW to allow the distance between the jaws 60, 61 to be increased. As best shown in FIG. 12, compression springs 71 are inserted into counterbores in the second jaw support 58 adjacent to the heads of the fasteners 67, and the springs 71 act on the underside surface of the heads to bias the jaw 60 away from the jaw 61. Alternatively, the distance between the jaws 60, 61 may be increased by moving the jaw 60 by hand.

The first and second tubing engagement structures 14 and 16 may include a first compression insert 70 and a second compression insert 72, respectively, as shown. The first and second compression inserts 70 and 72 are configured to fit over the first and second sets of jaws 34, 35 and 60, 61, respectively, and compress tubing therebetween. The first and second compression inserts 70 and 72 may be attached to the first and second jaw supports 32 and 58, respectively, using fasteners 74. The first and second compression inserts 70 and 72 may be made of plastic.

The first compression insert 70 has a tubing engagement surface 76 that is flat, a ledge 78, and a pocket 80 that is recessed relative to the tubing engagement surface 76, and a pair of projections 82 that protrude from the tubing engagement surface 76. The ledge 78 rests on the first jaw support 32 when the first compression insert 70 is installed. Holes 84 extend through the ledge 78 and receive the fasteners 74 that attach the first compression insert 70 to the first jaw support 32. Holes 86 extend through the tubing engagement surface 76 and receive pins 88 that are configured to support tubing. The pocket 80 is centered about the longitudinal midpoint of the first compression insert 70, and the projections 82 are disposed at opposite longitudinal ends of the first compression insert 70.

The second compression insert 72 has a tubing engagement surface 90 that is flat, a ledge 92, and a shoulder 94. The ledge 92 rests on the second jaw support 58 when the second compression insert 72 is installed. Holes 96 extend through the ledge 92 and receive the fasteners 74 that attach the second compression insert 72 to the second jaw support 58. Holes 98 extend through the tubing engagement surface 90 and receive the pins 88 that are configured to support tubing. The diameter of the holes 98 in the second compression insert 72 may be less than the diameter of the pins 88 to yield a press fit therebetween. Alternatively, the pins 88 may be formed together with the second compression insert 72 as one-piece structure.

The actuator 18 is manually operable to translate the first tubing engagement structure 14 along the track 12 in the first and second directions D1 and D2. The actuator 18 includes the threaded rod 100 and a control knob 102 that is fixed on the threaded rod 100, which may be referred to as a linear module shaft. As best shown in FIG. 13, the threaded rod 100 extends through the first end cap 22, has external threads 103 that engage internal threads 104 of the nut 105 fixed inside the carriage 30, and extends into the second end cap 24. The control knob 102 may be connected to the threaded rod 100 using a press fit and/or fasteners.

The control knob 102 is rotatable by hand to translate the first tubing engagement structure 14 along the track 12 via the engagement between the external threads 103 on the threaded rod 100 and the internal threads 104 of the nut 105 fixed inside the carriage 30. Thus, the actuator 18 is a screw-type mechanical linear actuator. Other types of linear actuators may be used to translate the first tubing engagement structure 14 along the track 12, such as a slider-crank linkage or an electro-mechanical actuator in which an electric motor replaces the control knob 102.

The first end cap 22 is connected to one end of the track 12, and the second end cap 24 is connected to the other end of the track 12. The first and second end caps 22 and 24 act as spacers to raise the tubing weld test assembly 10 and thereby provide clearance for rotation of the control knob 102. The first and second end caps 22 and 24 act as bearings by supporting the threaded rod 100 while allowing the threaded rod 100 to rotate. Each of the first and second end caps 22 and 24 includes an upper block 106 and a lower block 108 that are attached to one another using the fasteners 66.

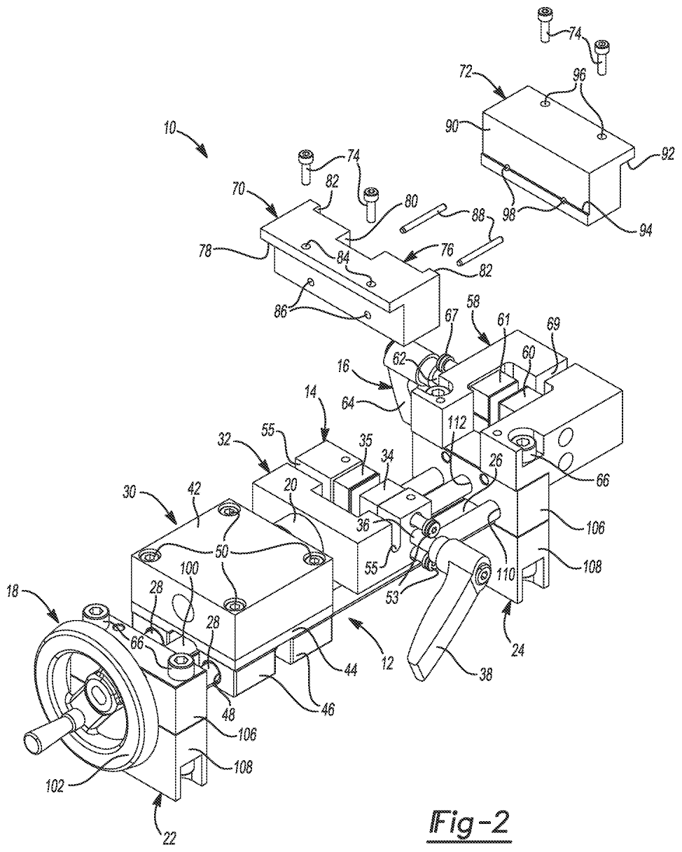

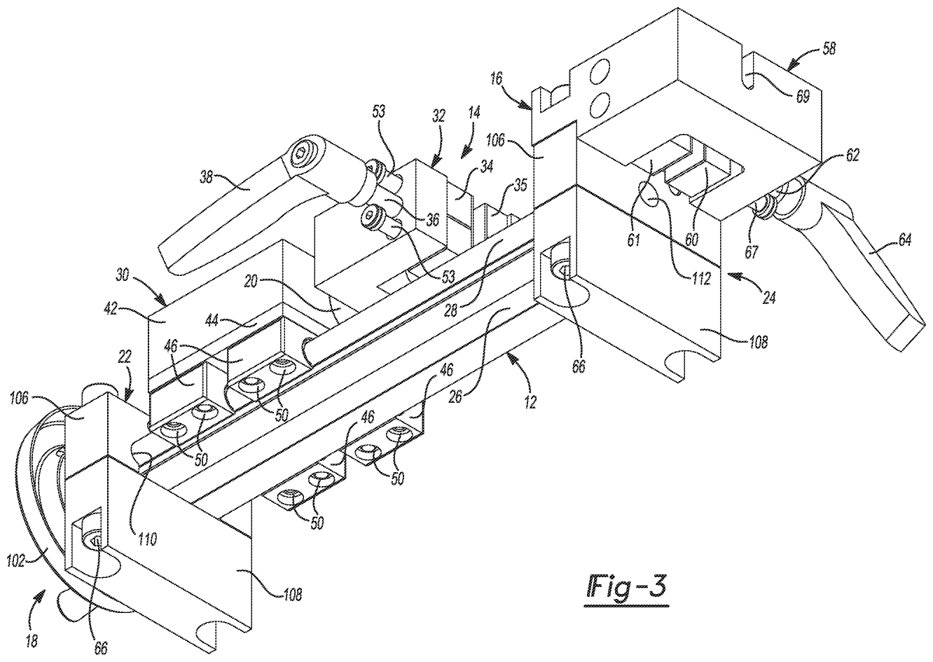

As best shown in FIGS. 2 and 3, each upper block 106 has an irregular-shaped blind hole 110 that receives the track 12 and a cylindrical through-hole 112 that receives the threaded rod 100. The shape of the blind hole 110 in the upper block 106 corresponds to the outer perimeter of the track 12. The bottom of the blind hole 110 may be open, and the track 12 may be captured between each pair of the upper and lower blocks 106 and 108. One or more dimensions of the blind hole 110 may be less than the corresponding dimension(s) of the track 12 so that the upper and lower blocks 106 and 108 clamp the track 12 therebetween as the fasteners 66 are tightened.

The load cell 20 measures a compression load and/or a tensile load applied to tubing by the first and second tubing engagement structures 14 and 16. The load cell 20 may measure a peak value of the tensile load applied to tubing as the first tubing engagement structure 14 is translated away from the second tubing engagement structure 16. The load cell 20 may measure a peak value of the compression load applied to tubing as the first tubing engagement structure 14 is translated toward the second tubing engagement structure 16. The load cell 20 may be calibrated using measurement standards traceable to the International System of Units through a National Metrology Institute such as the U.S. National Institute of Standards and Technology.

The tubing weld test assembly 10 may further include an electronic display 114 (FIG. 1) configured to display the compression load and/or the tensile load measured by the load cell 20. The load cell 20 outputs a signal to the electronic display 114 indicating the compression load and/or the tensile load measured by the load cell 20. The electronic display 114 may communicate with the load cell 20 using a wired or wireless signal 116.

In various implementations, the electronic display 114 may be a touchscreen and/or part of a device that allows a user to adjust aspects of the loads measured by the load cell 20 using, for example, the touchscreen or buttons on the device. The electronic display 114 or the device may include memory for storing instructions and a processor for executing certain ones of the instructions based on input received from the user. In addition, the electronic display 114 or the device may supply power to the load cell 20 and/or the load cell 20 may be powered by a battery (not shown) included in the tubing weld test assembly 10. The electronic display 114 or the device may be separate from (i.e., not connected to) the tubing weld test assembly 10, in which case the tubing weld test assembly 10 and the electronic display 114 (or the device) may be collectively referred to as a tubing weld test system.

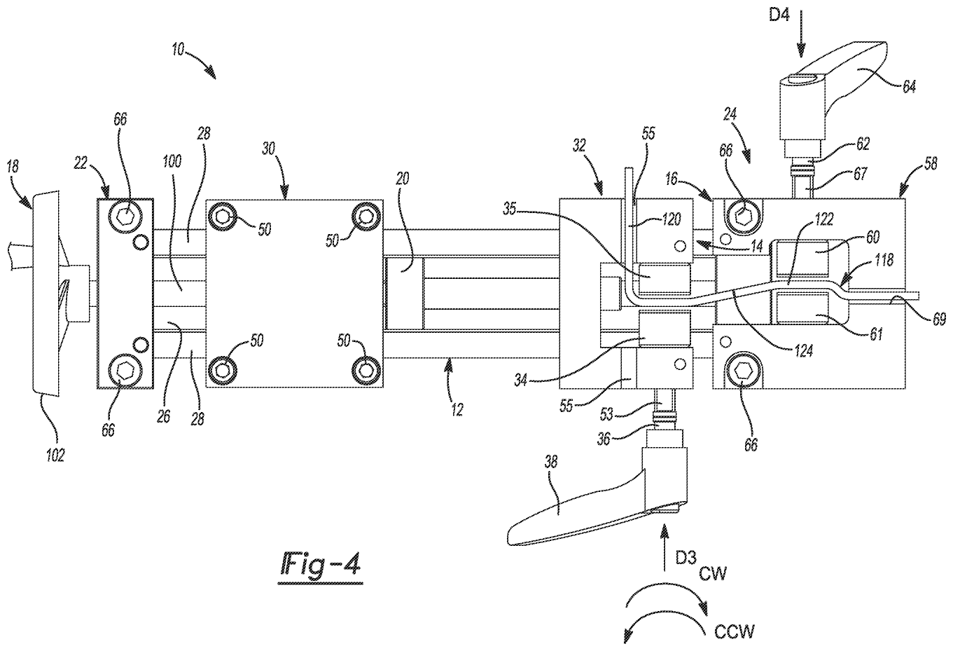

Referring now to FIGS. 4 through 6, operation of the tubing weld test assembly 10 to measure pull-strength of tubing 118 will now be described. The tubing 118 includes a first section 120 and a second section 122 that are joined together by a weld 124. When using the tubing weld test assembly 10 to measure the pull-strength of the tubing 118 (or any tubing), the first and second compression inserts 70 and 72 are not installed so that the first and second sets of jaws 34, 35 and 60, 61 are accessible.

Before inserting the tubing 118 into the tubing weld test assembly 10, the handles 38, 64 are rotated by hand in the counterclockwise direction CCW to adjust the first and second sets of jaws 34, 35 and 60, 61 to their open positions as shown in FIG. 4. Then, the first section 120 of the tubing 118 is inserted into one of the slots 55 and the first jaw support 32, and the second section 122 of the tubing 118 is inserted into the slot 69 and the second jaw support 58. The position of the tubing 118 within the slots 55, 69 may be adjusted until the weld 124 in the tubing 118 is about midway between the first and second tubing engagement structures 14 and 16 as shown in FIG. 4.

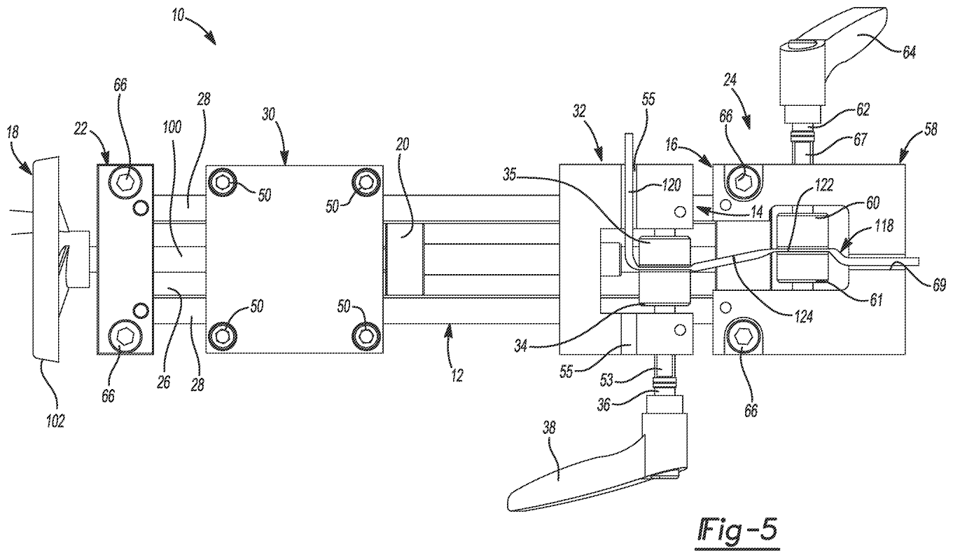

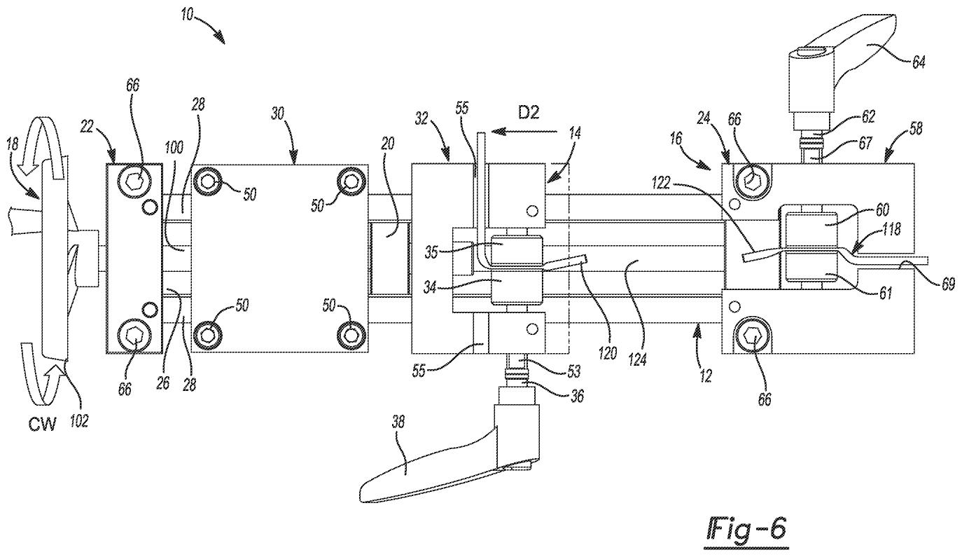

Once the tubing 118 is properly positioned within the slots 55, 69 in the first and second jaw supports 32 and 58, the first and second sets of jaws 34, 35 and 60, 61 are adjusted to their closed positions by rotating the handles 38, 64 by hand in the clockwise direction CW. When the first and second sets of jaws 34, 35 and 60, 61 are in their closed positions as shown in FIG. 5, the first section 120 of the tubing 118 is clamped between the jaws 34, 35, and the second section 122 of the tubing 118 is clamped between the jaws 60, 61. Then, the control knob 102 is rotated by hand in the clockwise direction CW to move the first tubing engagement structure 14 in the second direction D2 away from the second tubing engagement structure 16 as shown in FIG. 6.

As the first tubing engagement structure 14 is moved away from the second tubing engagement structure 16, the load cell 20 measures the tensile load applied to the tubing 118 by the first and second tubing engagement structures 14 and 16. The first tubing engagement structure 14 is moved away from the second tubing engagement structure 16 until the weld 124 in the tubing 118 breaks as shown in FIG. 6. The load cell 20 outputs the peak value of the tensile load applied to the tubing 118, which corresponds to a time just before the weld 124 breaks, and the electronic display 114 displays the peak value of the tensile load. The load cell 20 may continuously output the tensile load applied to the tubing 118 and update the peak value of the tensile load as it changes, and the electronic display 114 may continuously display and/or store the current and/or peak values of the tensile load.

Once the peak value of the tensile load is recorded, the first and second sets of jaws 34, 35 and 60, 61 are adjusted to their open positions by rotating the handles 38, 64 by hand in the counterclockwise direction CCW. The tubing 118 is then removed from the tubing weld test assembly 10. In addition, the first tubing engagement structure 14 may be returned to its original position by rotating the control knob 102 by hand in the counterclockwise direction CCW. Furthermore, the operator may touch the electronic display 114 to reset the peak value of the tensile load.

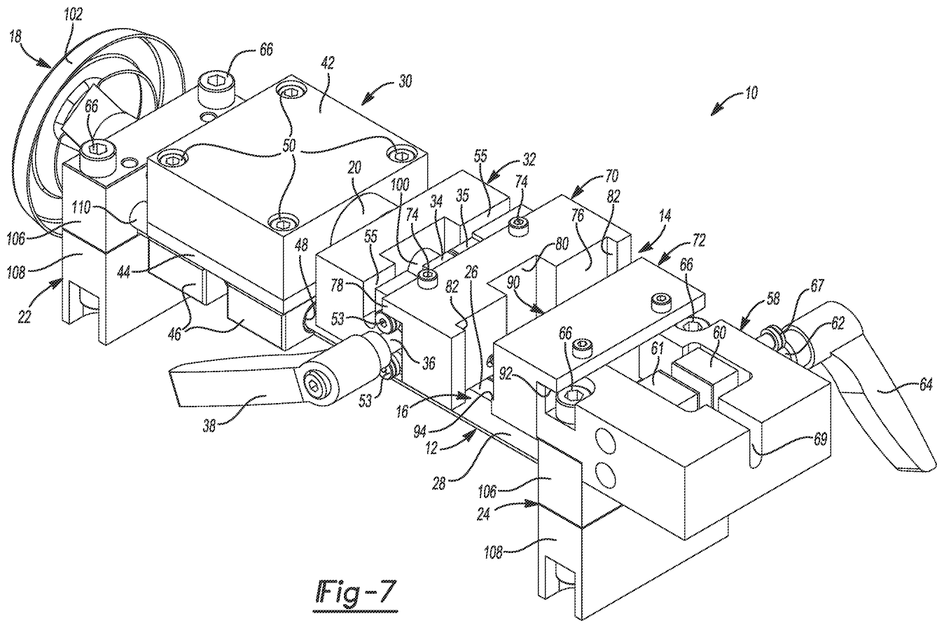

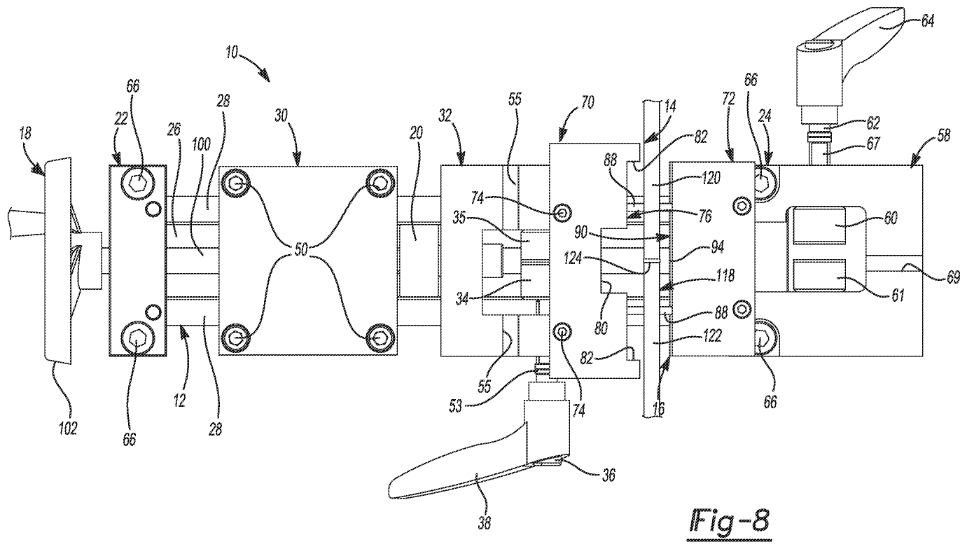

Referring now to FIGS. 7 through 9, operation of the tubing weld test assembly 10 to measure burst strength of the tubing 118 will now be described. When using the tubing weld test assembly 10 to measure the burst strength of the tubing 118 (or any tubing), the first and second compression inserts 70 and 72 are installed as shown in FIG. 7. The tubing 118 is filled with fluid, sealed at both ends thereof, and inserted between the first and second compression inserts 70 and 72 so that the tubing 118 is supported by the pins 88 and the weld 124 in the tubing 118 is aligned with the pocket 80 in the first compression insert 70 as shown in FIG. 8.

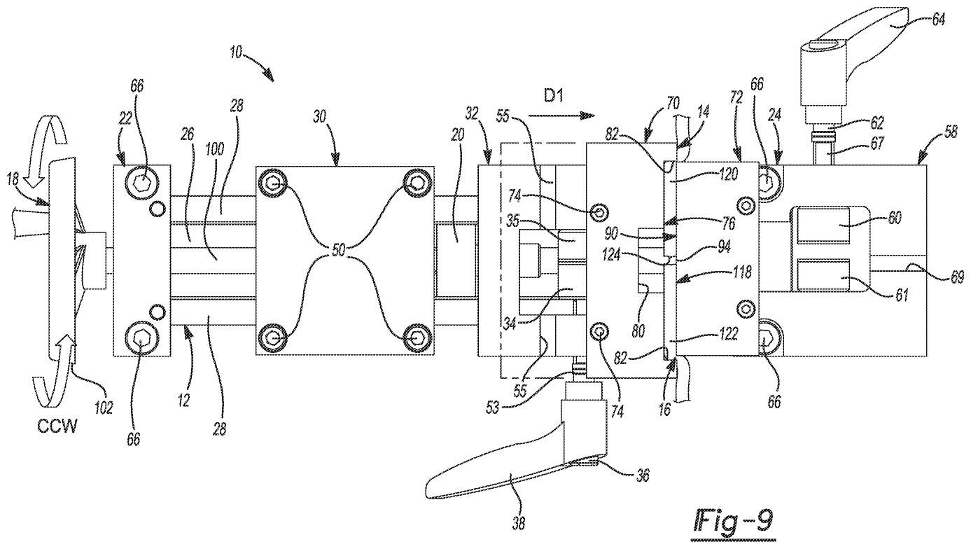

Once the tubing 118 is properly positioned between the first and second compression inserts 70 and 72, the control knob 102 is rotated by hand in the counterclockwise direction CCW to move the first tubing engagement structure 14 in the first direction D1 toward the second tubing engagement structure 16 as shown in FIG. 9. As the first tubing engagement structure 14 is moved toward the second tubing engagement structure 16, the tubing 118 is compressed between the first and second compression inserts 70 and 72. The first tubing engagement structure 14 is moved toward the second tubing engagement structure 16 until the weld 124 in the tubing 118 bursts.

The load cell 20 outputs the peak value of the compression load applied to the tubing 118, which corresponds to a time just before the weld 124 bursts, and the electronic display 114 displays the peak value of the compression load. The load cell 20 may continuously output the compression load applied to the tubing 118 and update the peak value of the compression load as it changes, and the electronic display 114 may continuously display and/or store the current and/or peak values of the compression load.

Once the peak value of the compression load is recorded, the first tubing engagement structure 14 has moved away from the second tubing engagement structure 16 by rotating the control knob 102 by hand and the clockwise direction CW. The tubing 118 is then removed from the tubing weld test assembly 10. In addition, the operator may touch the electronic display 114 to reset the peak value of the compression load.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in a different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the phrase at least one of A, B, and C should be construed to mean a logical (A OR B OR C), using a non-exclusive logical OR, and should not be construed to mean “at least one of A, at least one of B, and at least one of C.” As used herein, the term “and/or” includes any and all combinations of one or more of the associated listed items.

What is claimed is:

1. An assembly for testing a quality of a weld joining a first section of tubing to a second section of the tubing, the assembly comprising:
a track;
a first tubing engagement structure coupled to the track and translatable along the track;
a second tubing engagement structure connected to the track;
an actuator operable to translate the first tubing engagement structure along the track in a first direction toward the second tubing engagement structure and in a second direction away from the second tubing engagement structure; and
a load cell operable to measure at least one of a compression load and a tensile load applied to the tubing by the first and second tubing engagement structures.

2. The assembly of claim 1, wherein the actuator is manually operated.

3. The assembly of claim 2, wherein
the assembly further includes:
a first end cap connected to a first end of the track, and
a second end cap connected to a second end of the track; and
the actuator includes:
a threaded rod, and
a control knob,
the threaded rod extending through the first end cap, engaging internal threads in the first tubing engagement structure, and extending into the second end cap, and
the control knob being connected to the threaded rod and is rotatable by hand to translate the first tubing engagement structure along the track.

4. The assembly of claim 3, wherein:
the first tubing engagement structure includes:
a carriage coupled to the track,
a first jaw support connected to the carriage, and
a first set of jaws mounted to the first jaw support and adjustable to clamp and release the first section of the tubing; and
the second tubing engagement structure includes:
a second jaw support connected to the second end cap, and
a second set of jaws mounted to the second jaw support and adjustable to clamp and release the second section of the tubing.

5. The assembly of claim 4, wherein the load cell connects the first jaw support to the carriage.

6. The assembly of claim 4, wherein the load cell is operable to measure a peak value of the tensile load applied to the tubing as the first tubing engagement structure is translated away from the second tubing engagement structure.

7. The assembly of claim 4, wherein:
the first tubing engagement structure includes:
a first threaded shaft, and
a first handle fixed to the first threaded shaft,
the first threaded shaft extending into the first jaw support in a third direction and engaging one jaw of the first set of jaws,
the first handle being rotatable to adjust a distance between the first set of jaws; and
the second tubing engagement structure includes:
a second threaded shaft, and
a second handle fixed to the second threaded shaft,
the second threaded shaft extending into the second jaw support in a fourth direction and engaging one jaw of the first set of jaws,
the second handle being rotatable to adjust a distance between the second set of jaws.

8. The assembly of claim 4, wherein:
the first tubing engagement structure includes a first compression insert configured to be attached to the first jaw support and to provide a flat surface for pressing against a first side of the tubing at the weld; and
the second tubing engagement structure includes a second compression insert configured to be attached to the second jaw support and to provide a flat surface for pressing against a second side of the tubing at the weld.

9. The assembly of claim 8, wherein the load cell is operable to measure a peak value of the compression load applied to the tubing as the first tubing engagement structure is translated toward the second tubing engagement structure.

10. The assembly of claim 8, wherein the first and second compression inserts are configured to fit over the first and second sets of jaws, respectively.

11. The assembly of claim 8, wherein the first and second jaw supports and the first and second sets of jaws include metal, and the first and second compression inserts include plastic.

12. The assembly of claim 1, wherein the track extends through the first tubing engagement structure and into the second tubing engagement structure.

13. The assembly of claim 1, wherein the assembly further includes an electronic display configured to display the at least one of the compression load and the tensile load measured by the load cell.

14. An assembly for testing a quality of a weld joining a first section of tubing to a second section of the tubing, the assembly comprising:
a first tubing engagement structure configured to engage at least one of the first section of the tubing and a first side of the tubing at the weld;
a second tubing engagement structure configured to engage at least one of the second section of the tubing and a second side of the tubing at the weld;
an actuator that is manually operable to adjust a distance between the first and second tubing engagement structures; and
a load cell operable to measure at least one of a compression load and a tensile load applied to the tubing by the first and second tubing engagement structures.

15. The assembly of claim 14, wherein the assembly further includes:
a track
the first tubing engagement structure being coupled to the track,
the second tubing engagement structure being fixed relative to the track, and
the actuator being operable to translate the first tubing engagement structure along the track.

16. The assembly of claim 15, wherein
the assembly further includes:
a first end cap connected to a first end of the track, and
a second end cap connected to a second end of the track; and
the actuator includes:
a threaded rod, and
a control knob,
the threaded rod extending through the first end cap, engaging internal threads in the first tubing engagement structure, and extending into the second end cap, and
the control knob is connected to the threaded rod and is rotatable by hand to translate the first tubing engagement structure along the track.

17. An assembly for testing a quality of a weld joining a first section of tubing to a second section of the tubing, the assembly comprising:
a first tubing engagement structure including:
a first jaw support, and
a first set of jaws mounted to the first jaw support and adjustable to clamp and release the first section of the tubing;
a second tubing engagement structure including:
a second jaw support, and
a second set of jaws mounted to the second jaw support and adjustable to clamp and release the second section of the tubing;
an actuator operable to move the first tubing engagement structure in a first direction toward the second tubing engagement structure and in a second direction away from the second tubing engagement structure; and
a load cell operable to measure at least one of a compression load and a tensile load applied to the tubing by the first and second tubing engagement structures.

18. The assembly of claim 17, wherein the assembly further includes:
a track,
the first tubing engagement structure including a carriage coupled to the track and supporting the first jaw support,
the second tubing engagement structure is fixed relative to the track, and
the actuator is operable to translate the first tubing engagement structure along the track.

19. The assembly of claim 17, wherein:
the first tubing engagement structure includes:
a first threaded shaft, and
a first handle fixed to the first threaded shaft,
the first threaded shaft extending into the first jaw support in a third direction perpendicular to the first and second directions, and the first handle being rotatable to adjust a distance between the first set of jaws; and
the second tubing engagement structure includes:
a second threaded shaft, and
a second handle fixed to the second threaded shaft,
the second threaded shaft extending into the second jaw support in a fourth direction opposite of the third direction, and
the second handle is rotatable to adjust a distance between the second set of jaws.

20. The assembly of claim 17 wherein:
the first tubing engagement structure includes a first compression insert configured to be attached to the first jaw support and to provide a flat surface for pressing against a first side of the tubing at the weld; and
the second tubing engagement structure includes a second compression insert configured to be attached to the second jaw support and to provide a flat surface for pressing against a second side of the tubing at the weld.
